(19) United States
(12) Patent Application Publication
(10) Pub. No.: US 2013/0343147 A1
(43) Pub. Date: Dec. 26, 2013

(54) MIXING DEVICE

(71) Applicant: Haldor Topsoe A/S, Kgs. Lyngby (DK)

(72) Inventors: Søren Heinesen, Copenhagen (DK); Jesper Norsk, Humlebaek (DK); Helbo Anders Hansen, Frederiksberg (DK); Juul Anders Rasmussen, Glostrup (DK)

(73) Assignee: HALDOR TOPSOE A/S, Kgs. Lyngby (DK)

(21) Appl. No.: 14/003,845

(22) PCT Filed: Mar. 23, 2012
(86) PCT No.: PCT/EP2012/001279

§ 371 Date: Sep. 9, 2013

(30) Foreign Application Priority Data
Mar. 28, 2011 (EP) PCT EP2011/001545

(51) Int. Cl. B01F 5/04

(52) U.S. Cl. CPC B01F 5/04
USPC 366/107

(57) ABSTRACT

The present invention relates to a mixing device for mixing a first gas with a second gas by means of a plurality of sets of injection and mixing ducts, wherein at least one of the gases is corrosive to the mixing device and the mixing device is thus constructed in corrosion resistant ceramic material.

The present invention relates to a mixing device. The present invention further relates to a method for mixing. In particular, the present invention relates to a mixing device for mixing two or more gases. The mixing device may be part of a large apparatus, such as a production apparatus.

When mixing gases wherein at least one gas is corrosive to the mixing device, there is a need for protecting the mixing device. This may be achieved using specific corrosion resistant metallic materials or by applying lining or coating to the interior of the mixing device. In some applications the temperature is to high for the safe use of metallic materials or polymeric materials. The present invention provides a device that reduces at least these problems.

In a first aspect, the present invention relates to a mixing device for mixing a first gas with a second gas wherein at least one of the first or the second gas is corrosive, the mixing device comprising a first inlet section, a second inlet section, an outlet section, a first duct sheet, a second duct sheet, a distribution chamber, at least two injection ducts arranged in said first duct sheet and at least two mixing ducts arranged in said second duct sheet. The space between the first duct sheet and the second duct sheet forms the distribution chamber and each of the at least two injection ducts corresponds to one of said at least two mixing ducts. This means that each injection duct is in flow relation to a mixing duct, such that each pair of ducts will perform mixing of the two gasses when the gasses stream through the mixing ducts.

The arrangement of the mixing device is contemplated to allow the gases to mix by means of the injection principle, and in the case where the two gasses have different temperatures, the temperature of the relative colder gas will increase during the injection mixing process in each mixing duct. This is advantageous if the colder gas is a wet corrosive gas, as it can raise the temperature of the corrosive gas above its dew-point, whereby the need for corrosion resistant materials on the inner surface of the equipment downstream of the mixing duct is reduced or removed. In an embodiment of the invention, the mixing device itself is however at least partly made of ceramic materials in order to withstand corrosion from at least one corrosive gas of the two gasses to be mixed.

In an embodiment of the invention, the first and the second duct sheets, the distribution chamber and the at least two injection ducts and corresponding mixing ducts are at least partly made of ceramic materials, to protect the equipment against corrosion induced by one or both the gasses.

In a further embodiment of the invention, the circumference of the outlet of each of the at least two injection ducts is equal to or smaller than the circumference of the corresponding mixing duct and each injection duct outlet centre-line is arranged in an angle of 0° to 90° to the corresponding mixing duct inlet centre-line. These restrictions to the size of corresponding duct pairs and of their centre-lines according to this embodiment of the invention, provides that substantially all the gas flow leaving an injection duct further on streams through its corresponding mixing duct and when doing so it draws the other gas stream through the mixing duct, thereby performing an injection.

In an embodiment, the centre line relationship is further restricted so that each injection duct outlet centre-line is arranged substantially parallel to the corresponding mixing duct inlet centre-line and said circumference of the outlet of each of the at least two injection ducts is arranged within the circumference of the inlet of the corresponding mixing duct in cross sectional view. Thus, the gas flow from the injection duct is not forced to change direction when entering the corresponding mixing duct, and possible deflection of the injection gas flow by the mixing duct edges is minimized. These restrictions enables a further embodiment where the at least two injection ducts are arranged partly within the corresponding mixing ducts, whereby each of the at least two mixing ducts overlaps the corresponding injection ducts. This ensures that there is no risk of deflection of the injection gas flow stream when leaving the injection duct and entering the mixing duct, but still the injection gas flow stream can draw the other gas into the mixing duct as there is a gap between the injection duct outlet circumference and the mixing duct inlet circumference.

Instead of tubes, the injection ducts as well as the mixing ducts can be formed as bores in the first and the second duct sheets in further embodiments. However, if the injection ducts are to be arranged partly within the mixing ducts, the injection ducts off course have to be formed at least partly as tubes.

In an embodiment of the invention, the two inlet sections and the outlet section are arranged such that the flow direction of the first gas in the first inlet section is substantially perpendicular to the flow direction of the second gas. This embodiment allows for a relative simple construction of the mixing device.

In a further embodiment either the first or the second gas is a relative cold gas (in this context relative means one of the two gasses relative to the other of the two gasses), with a temperature below its dew point and the other gas is a relative hot gas with a temperature above its dew point, and the condensate of either or both the first and the second gas is corrosive. In a further embodiment of the invention, the mixing zone is formed within each of said at least two mixing ducts and the gas leaving said at least two mixing ducts has an average temperature above the dew point of the perfectly mixed gas. This embodiment ensures that even though one of the two gasses to be mixed has a temperature below its dew point, which means that it may be corrosive, the mix of the two gasses has a temperature above the dew point of the perfectly mixed gas which minimizes the corrosive properties. Mixing of the two gas streams starts just before the inlet of the mixing ducts, or in the mixing ducts, but a perfect mix which ensures that all droplets have vaporised may not have taken place until a distance after the mixing duct outlets. Therefore the gas stream leaving the mixing ducts may be corrosive when passing this distance and the mixing ducts as well as the duct or channel material in contact with the gas stream a distance after the mixing ducts may be made of corrosion resistant materials. These corrosion resistant materials can be ceramic materials.

In an embodiment of the invention, the corrosion resistant materials can comprise at least one of: silicon carbide based materials, including reaction sintered, nitride bonded oxide bonded and oxynitride bonded types; oxide based materials, including types based on silica or alumina; or silicate and borosilicate based materials, including glass, wherein said materials can be either impermeable or permeable to gas and liquid.

In a further embodiment of the invention, at least one of the first or the second inlet section comprises a circumferential crevice adapted to pass a purge gas into said first or second inlet section. As this purge gas enters circumferential, it can contribute to a corrosion protection of the equipment as it can wrap a non-corrosive purge gas around a corrosive process gas, such that the corrosive process gas is not in contact with the surrounding duct or channel material, hence the corrosion protection by means of for instance ceramic material can be reduced or omitted in the area where the purge gas isolates the material from the corrosive gas.

In a second aspect, the present invention is a method for mixing a first gas and a second gas, the method comprises the steps of providing a mixing device for mixing the first gas with the second gas, the mixing device comprises: A first inlet section, a second inlet section and an outlet section; a first duct sheet a second duct sheet and a distribution chamber; at least two injection ducts arranged in said first duct sheet and at least two mixing ducts arranged in said second duct sheet, wherein the space between the first duct sheet and the second duct sheet forms the distribution chamber. In a following step a first flow comprising the first gas is provided at the first inlet section and a second flow comprising the second gas is provided at the second inlet section and in a following step the first gas and the second gas is mixed in a mixing zone formed within each of the at least two mixing ducts. One of the two gasses (the first and the second gas) is a relative cold corrosive gas with a temperature below its dew point and the other gas is a relative hot corrosive gas with a temperature above its dew point. Therefor the mixing device is at least partly made of ceramic materials which are able to withstand the corrosion of the gas.

In an embodiment of this second aspect of the invention, the first and the second duct sheets, the distribution chamber, the at least two injection ducts and their corresponding mixing ducts are made of corrosion resistant ceramic materials.

In a further embodiment, the first gas is a relative cold corrosive gas with a temperature below its dew point and the second gas is a relative hot corrosive gas with a temperature above its dew point. Yet a further embodiment specifies that the temperature of the first gas in the first inlet section is in the range of 0° C.-200° C., preferably in the range of 145° C.-180° C. and the second gas has a temperature in the second inlet section in the range of 300° C.-600° C., preferably in the range of 360° C.-450° C.

In an embodiment of the invention, the first gas and the second gas are mixed by means of injection.

In yet a further embodiment of the invention, the temperature of the mixed gas after the outlet section is above the dew point of the perfectly mixed gas. In this context, perfectly mixed gas means the gas mixed of the first and the second gas where the temperature and the content of the gas is homogenous. The mixture of the first and the second gas is not necessarily entirely homogenous right after leaving the mixing zone, the temperature and the content of the mixture may vary slightly in different areas of the duct right after the mixing zone. Therefore it can be necessary to have corrosion resistant material in the duct in a distance after the mixing zone, the distance can vary depending of the process parameters.

In a further specific embodiment of the invention, the first gas comprises SO₃ and H₂O and has a temperature below the H₂SO₄ dew point, and said gas thus comprises droplets or mist of the liquid phase of the gas.

In a further embodiment of the invention, the mixing device is used in a plant for production of sulphuric acid.

The features and advantages mentioned in relation to the first and second aspect may apply equally to the other aspects of the present invention.

The present invention will be discussed in more detail with reference to the embodiments in the drawings in which:

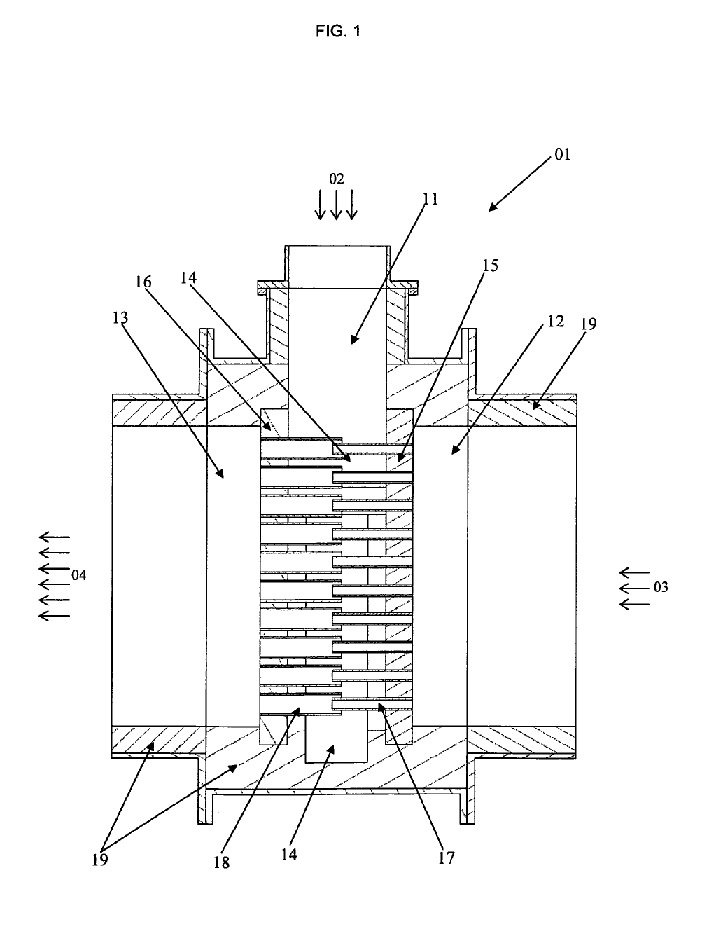

FIG. 1 is a cross section view of one embodiment of a mixing device,

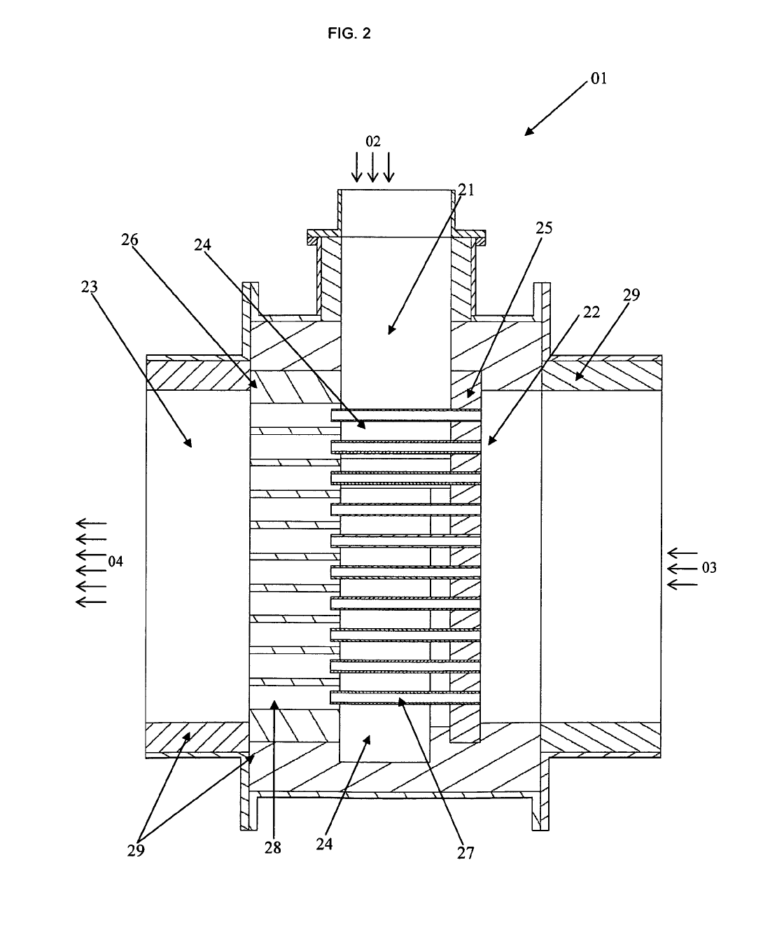

FIG. 2 is a cross section view of another embodiment of a mixing device,

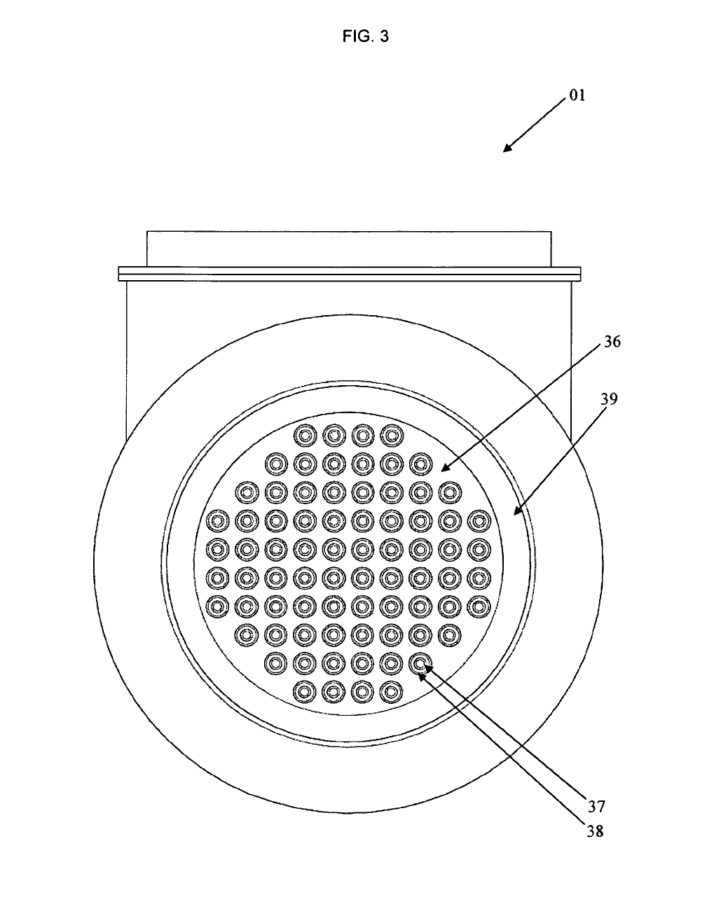

FIG. 3 is an end view of the outlet section of the mixing device,

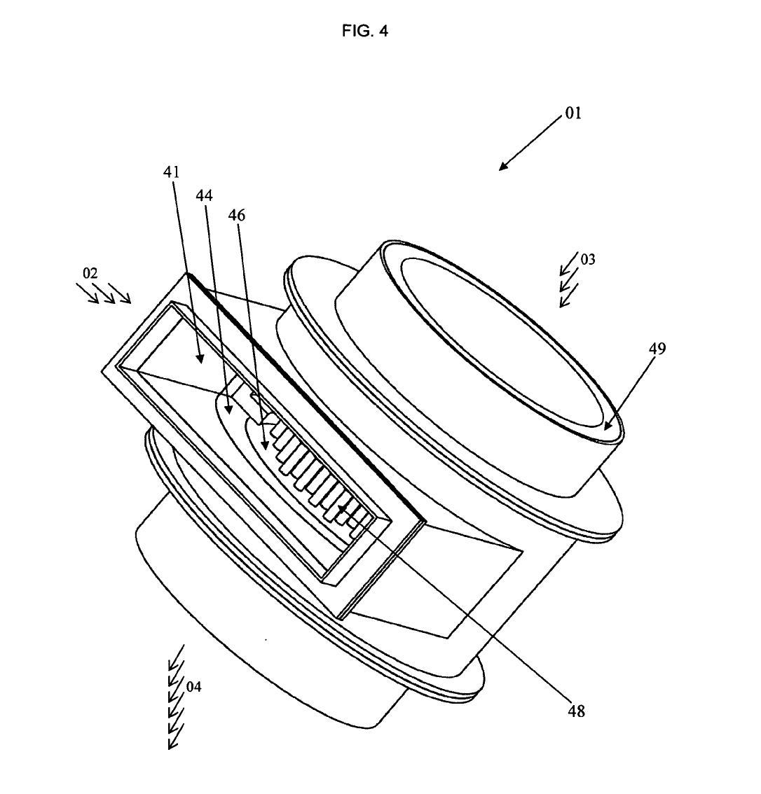

FIG. 4 is an isometric view of an embodiment of the mixing device,

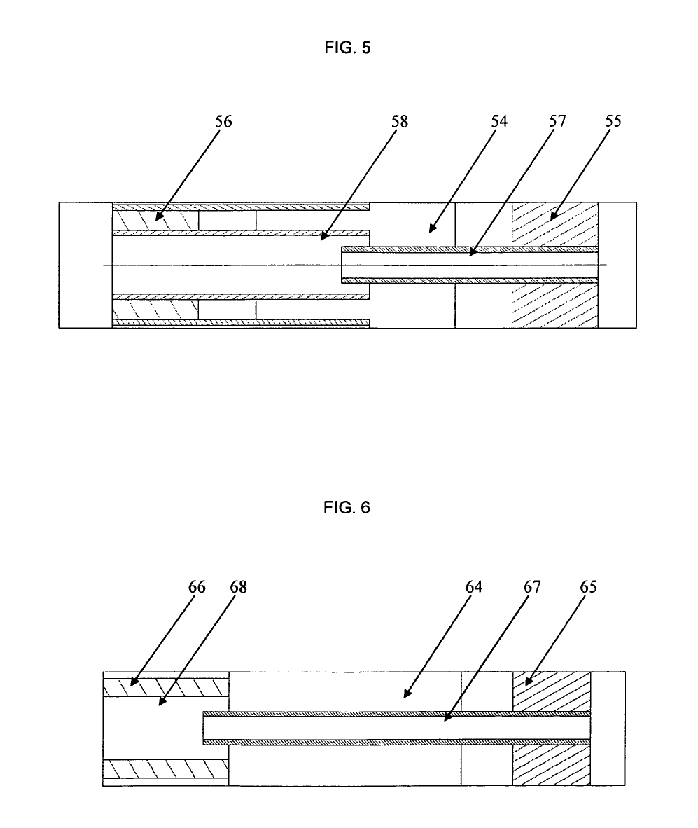

FIG. 5 is a detail view of an injection duct and a corresponding mixing duct according to one embodiment of a mixing device.

FIG. 6 is a detail view of an injection duct and a corresponding mixing duct according to another embodiment of a mixing device.

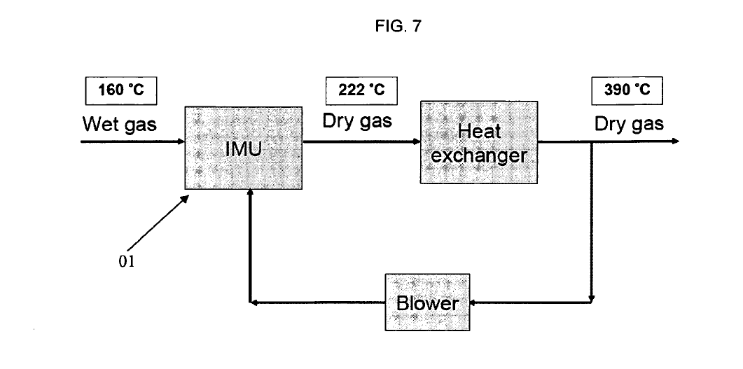

FIG. 7 is a flow diagram of an application for the mixing device (IMU).

### POSITION NUMBER OVERVIEW

| | |
|---|---|
| 01. | Mixing device. |
| 02. | First gas. |
| 03. | Second gas. |
| 04. | Mixed gas. |
| 11, 21, 41. | First inlet section. |
| 12, 22. | Second inlet section. |
| 13, 23. | Outlet section. |
| 14, 24, 44, 54, 64. | Distribution chamber. |
| 15, 25, 55, 65. | First duct sheet. |
| 16, 26, 36, 46, 56, 66. | Second duct sheet. |
| 17, 27, 37, 57, 67. | Injection duct. |
| 18, 28, 38, 48, 58, 68. | Mixing duct. |
| 19, 29, 39, 49. | corrosion resistant material. |

FIG. 1 Shows an embodiment of the mixing device 01 in a cross section view. It comprises a central distribution chamber 14 which is delimited by two duct sheets, a first duct sheet 15 and a second duct sheet 16. The device has two inlet sections, first inlet section 11 and second inlet section 12, leading into the distribution chamber, and a single outlet section 13. The cross sectional shape of the distribution chamber is in FIG. 1 shown as circular, but it is to be understood that it can have any convenient shape. The first duct sheet is arranged in the second inlet section. It is fitted with at least two injection ducts 17 which stretch into the distribution chamber. In the embodiment of FIG. 1, the injection ducts are in the form of tubes. Hence, each of the injection ducts has a defined outer diameter and a defined inner diameter. The second duct sheet is arranged in the outlet section. In the embodiment shown in FIG. 1, It is fitted with mixing ducts 18 in the form of tubes, having a defined outer diameter and a defined inner diameter. The mixing ducts stretch into the distribution chamber. The number of mixing ducts is the same as the number of injection ducts, each mixing duct is arranged in the second duct sheet to correspond with an injection duct which means that the centre line of an injection duct is the same or very close the centre line of the corresponding mixing duct and the pairs of centrelines are also aligned. In the embodiment of the invention according to FIG. 1, the inlet end of each mixing duct is overlapping the outlet end of the corresponding injection duct. Thus, the inlet end each mixing duct must have an inner diameter which is larger than the outer diameter of the corresponding injection duct outlet end. In other embodiments of the invention (not shown on the figures), the mixing ducts do not overlap their corresponding injection ducts. In those cases, the inner diameter of the mixing duct inlet ends does not necessarily have to be larger than the outer diameter of their corresponding injection duct outlet end.

A first gas 02 enters the mixing device via the first inlet section and flows into the distribution chamber. A second gas 03 enters the mixing device via the second inlet section and flows into the injection ducts. Mixing of the first and the second gas takes place inside the mixing ducts as the second gas flows from each of the injection ducts into the corresponding mixing ducts and by means of the injection effect the first gas is drawn along into each mixing duct. From the mixing ducts, the fully or partly mixed gas 04 flows to the outlet section.

The mixing device may be partly or fully lined with or constructed by a corrosion and temperature resistant material such as a ceramic material. The embodiment according to FIG. 1 has injection ducts, mixing ducts and duct sheets made entirely of a ceramic material, whereas the inlet section, the outlet section and the distribution chamber is made of metal but provided with a ceramic lining 19. Depending on the process parameters and the construction of the mixing device, the first and the second gas may not be perfectly mixed when leaving the mixing ducts. Therefore corrosive droplets may occur in the gas leaving the mixing ducts. This is the reason why the outlet section in the embodiment according to FIG. 1 also is lined with corrosion resistant material. When the first and the second gas is perfectly mixed further down-stream from the mixing device, the corrosion resistant material may be omitted.

In an other embodiment of the invention, only the injection ducts 27 are in the form of tubes, whereas the mixing ducts 28 are formed as bores in the second duct sheet 26. This embodiment is simpler than the embodiment according to FIG. 1 as it requires fewer components, however the second duct sheet may need to be thicker. The first duct sheet 25, the distribution chamber 24, the outlet section 23, the first 21 and second 22 inlet section and the lining according to the embodiment of FIG. 2 does not differ significant from the embodiment of FIG. 1.

FIG. 3 shows an end view of the outlet section of the mixing device according to the embodiment of the invention shown in FIG. 1. The outlet section is lined 39 with a corrosion resistant material. The mixing ducts 38 are arranged evenly distributed in the second duct sheet 36. Within the circumference of each of the mixing ducts, an injection duct 37 is visible. As shown on FIG. 3, each injection duct is placed concentrically with its corresponding mixing duct. The inside diameter of each mixing duct is larger than the outside diameter of the corresponding injection duct, hence the visible free annulus between two corresponding ducts.

FIG. 4 has the mixing device embodiment according to FIG. 1 shown in an isometric view, whereby the first inlet section 41 and a part of the distribution chamber 44 is visible. Also a number of the mixing ducts 48 arranged in the second duct sheet 46 can be seen. As already described, the device is provided with a ceramic lining 49. The first 02 and second 03 gas entering the mixing device are symbolised with arrows, as is the mixed gas 04 exiting the device.

FIG. 5 and FIG. 6 show in detail a set of corresponding injection and mixing ducts according to two embodiments of the invention.

On FIG. 5 a detailed view of a set corresponding injection 57 and mixing ducts 58 according to the embodiment of FIG. 1 is shown. The injection duct is arranged in the first duct sheet 55 and the mixing duct is arranged in the second duct sheet 56. Both ducts are in this embodiment in the form of tubes. The outside diameter of the outlet end of the injection duct is substantively smaller than the inside diameter of the inlet end of the mixing duct. The annulus thus leaving space for the first gas to enter the mixing duct by means of the injection effect formed by the second gas leaving the injection duct and entering the mixing duct. The space between the first and the second duct sheet forms the distribution chamber 54. It can be seen on the FIG. 5 how the mixing duct slightly overlaps the corresponding injection duct. This minimizes the risk of the second gas entering the distribution chamber, as it would have to flow a distance against the flow direction of the first gas in the annulus space.

On FIG. 6 a detailed view of a set corresponding injection 67 and mixing ducts 68 according to the embodiment of FIG. 2 is shown. In this embodiment only the injection ducts are in the form of tubes, whereas the mixing ducts are in the form of bores in the second duct sheet 66. The injection duct is arranged in the first duct sheet 65. The outside diameter of the outlet end of the injection duct is substantively smaller than the inside diameter of the inlet end of the mixing duct. The annulus thus leaving space for the first gas to enter the mixing duct by means of the injection effect formed by the second gas leaving the injection duct and entering the mixing duct. The space between the first and the second duct sheet forms the distribution chamber 64. Also in this embodiment the mixing duct slightly overlaps the corresponding injection duct, which has the same effect as in the embodiment of FIG. 5: to minimize the risk of the second gas entering the distribution chamber.

In cases (not shown on the figures) where the hot gas entering the mixing device has a composition which results in a dew point for any kind of corrosive species (e.g. mineral- or organic acids), the hot gas inlet to the mixing device can be constructed accordingly. In one embodiment the steel duct carrying the hot gas to the mixing device is overlapping a distance into the brick lined inlet section. A circumferential crevice is present between the steel duct and the inside surface of the brick lining. A purge gas is passed through this circumferential crevice. The purge gas ensures that hot gas cannot enter the area around the transition from brick lining to unprotected steel duct. The temperature of the purge gas shall be above the given dew point temperature of the hot gas. In another embodiment, the steel duct for the hot gas is overlapping a distance into the brick lined inlet section, leading to the first tube sheet. A circumferential crevice is present between the steel duct and the inside surface of the brick lining. The crevice is filled with insulation material which is attached to the outside surface of the steel duct. The steel duct is connected to the brick lined duct by a flange ring. This ring is positioned a distance from the end of the steel duct.

As described, to resist corrosion from condensate in the gas, the mixing device is constructed and/or lined with corrosion and temperature resistant ceramic materials in those sections of the device in contact with wet gas and where the temperature is at the same time too high for the use of metallic and polymeric materials. Applicable ceramic material types includes, but are not limited to:
Silicon carbide based materials, including reaction sintered, nitride bonded, oxide bonded and oxynitride bonded types.
Oxide based materials including types based on silicon dioxide and/or aluminia.
Silicate and borosilicate based materials, including glass.

Ceramic materials which are either impermeable or permeable to gas and liquid can be used.

In one embodiment, the mixing device works in two stages, in the first stage the device creates a distribution of hot gas and wet gas, which minimizes the influence of entrance effects (e.g. upstream bends, constraints etc.) and at the same time ensures a homogeneous gas distribution in the distribution chamber. The gasses are initially kept separate as the hot gas enters through the injection ducts and the wet gas distributes in the distribution chamber. The chamber is designed in such a manner that the cold wet gas distributes evenly in the entire chamber. In the second stage, a local mixing of the two gasses takes place inside each of the individual mixing ducts. These ducts are designed for optimization of mixing and minimization of wet gas pressure drop. The minimization of wet gas pressure drop is achieved by an injector design of the mixing ducts inlet region. This principle works for the described embodiments irrespective of whether the injection ducts are overlapping inside the mixing ducts or not.

### FEATURES OF THE INVENTION

1. A mixing device for mixing a first gas with a second gas wherein at least one of the first or the second gas is corrosive, the mixing device comprising:
a first inlet section
a second inlet section
an outlet section
a first duct sheet
a second duct sheet
a distribution chamber
at least two injection ducts arranged in said first duct sheet
at least two mixing ducts arranged in said second duct sheet,
   wherein the space between the first duct sheet and the second duct sheet forms the distribution chamber and each of said at least two injection ducts corresponds to one of said at least two mixing ducts and wherein said mixing device is at least partly made of ceramic materials.

2. A mixing device according to feature 1, wherein the first and the second duct sheets, the distribution chamber and the at least two injection ducts and corresponding mixing ducts are at least partly made of ceramic materials.

3. A mixing device according to any of the preceding features, wherein the circumference of the outlet of each of said at least two injection ducts is equal to or smaller than the circumference of the corresponding said mixing duct, each injection duct outlet centre-line is arranged in an angle of 0° to 90° to the corresponding mixing duct inlet centre-line.

4. A mixing device according to any of the preceding features, wherein each injection duct outlet centre-line is arranged substantially parallel to the corresponding mixing duct inlet centre-line and said circumference of the outlet of each of the at least two injection ducts is arranged within said circumference of the corresponding mixing duct in cross sectional view.

5. A mixing device according to any of the preceding features, wherein each of said at least two injection ducts are formed by an injection tube arranged in the first duct sheet.

6. A mixing device according to any of the preceding features, wherein each of said at least two mixing ducts are formed by a mixing tube arranged in the second duct sheet and the circumference of the outlet of each of said at least two injection ducts is equal to or smaller than the circumference of the corresponding said mixing tube.

7. A mixing device according to any of the features 1-4 or 6, wherein each of said at least two injection ducts are formed by a bore in the first duct sheet.

8. A mixing device according to any of the features 1-5 or 7, wherein each of said at least two mixing ducts are formed by a bore in the second duct sheet.

9. A mixing device according to any of the features 1-6 or 8, wherein the circumference of the outlet of each said at least two injection tubes is smaller than the circumference of the inlet of the corresponding mixing duct and each of the at least two injection tubes are arranged partly within the corresponding mixing duct, whereby each of the at least two mixing ducts partly overlaps the corresponding injection tube in an axial direction.

10. A mixing device according to any of the preceding features, wherein said first inlet section, said second inlet section and said outlet section is arranged such that the flow direction of the first gas in the first inlet section is substantially perpendicular to the flow direction of the second gas in the second inlet section.

11. A mixing device according to any of the preceding features, wherein either the first or the second gas is a relative cold gas with at temperature below its dew point and the other gas is a relative hot gas with a temperature above its dew point, and the condensate of either or both the first and the second gas is corrosive.

12. A mixing device according to any of the preceding features, wherein a mixing zone is formed within each of said at least two mixing ducts and the gas leaving said at least two mixing ducts has an average temperature above the dew point of the perfectly mixed gas.

13. A mixing device according to any of the preceding features, wherein said corrosion resistant ceramic materials comprises at least one of
silicon carbide based materials, including reaction sintered, nitride bonded, oxide bonded and oxynitride bonded types
oxide based materials, including types based on silica or alumina
silicate and borosilicate based materials, including glass,
   wherein said materials can be either impermeable or permeable to gas and liquid.

14. A mixing device according to any of the preceding features, wherein at least one of the first or the second inlet section comprises a circumferential crevice adapted to pass a purge gas into said first or second inlet section.

15. A method for mixing a first gas and a second gas, the method comprising the steps of:
providing a mixing device for mixing the first gas with the second gas, the mixing device comprising:
a first inlet section
a second inlet section
an outlet section
a first duct sheet
a second duct sheet
a distribution chamber
at least two injection ducts arranged in said first duct sheet
at least two mixing ducts arranged in said second duct sheet,
   wherein the space between the first duct sheet and the second duct sheet forms the distribution chamber and wherein said mixing device is at least partly made of ceramic materials,
providing a first flow comprising the first gas at the first inlet section,
providing a second flow comprising the second gas at the second inlet section,
mixing the first gas and the second gas in a mixing zone formed within each of the at least two mixing ducts, wherein the one of the two gasses is a relative cold corrosive gas with at temperature below its dew point and the other gas is a relative hot corrosive gas with a temperature above its dew point.

16. The method according to feature 15, wherein the first and the second duct sheets, the distribution chamber and the at least two injection ducts and corresponding mixing duct are made of corrosion resistant ceramic materials.

17. The method according to feature 15 or 16, wherein the first gas is a relative cold corrosive gas with at temperature below its dew point and the second gas is a relative hot corrosive gas with a temperature above its dew point.

18. The method according to feature 17, wherein the first gas has a temperature in the first inlet section in the range of 0° C.-200° C., preferably in the range of 145° C.-180° C. and the second gas has a temperature in the second inlet section in the range of 300° C.-600° C., preferably in the range of 360° C.-450° C.

19. The method according to any of the features 15-18, wherein the first gas and the second gas are mixed in the mixing zones by means of injection.

20. The method according to any of the features 15-19, wherein the temperature of the mixed gas after the outlet section is above the dew point of the perfectly mixed gas.

21. The method according to any of the features 15-20, wherein the first gas comprises SO₃ and H₂O and has a temperature below the H₂SO₄ dew point, and said gas thus comprises droplets of the liquid phase of the gas.

22. Use of a mixing device according to any of the features 1-14 for a Sulphuric-Acid plant.

### Example

The mixing device can be used for sulphuric acid producing plants, in which SO3 and H2O containing process gas may comprise sulphuric acid mist or droplets in certain sections of the process. This may be the case when the temperature is below the sulphuric acid dew point for a given gas composition. Handling such corrosive gasses most often requires use of expensive materials such as high alloyed steels or alloys, fluoropolymers or acid resistant refractory.

As preparation for certain unit operations in these plants, it is therefore desirable to dry op the wet corrosive gas. This makes the gas suitable for processing in e.g. unprotected carbon/low alloy steel equipment and ducting, which most often represents a much cheaper construction.

In cases where the dew point temperature is very high, traditional heat exchangers, constructed in acid resistant alloys or polymeric materials cannot sustain the conditions or have a limited operation window. In those cases the proposed mixing device according to the invention can be used safely and with much more flexibility for heating and drying the wet process gas.

FIG. 7 shows an example of the use of the mixing device (IMU, Injector type gas Mixer Unit). The dry hot gas used for heating, is in this case a recycle stream from the process gas downstream of the mixing device.

The dried and heated process gas exits the mixing device at a temperature somewhat above the dew point temperature. The gas is then heated further to approx. 390° C. in a regular heat exchanger made in carbon steel or low alloy steel.

Downstream of this heat exchanger about ⅓ of the hot gas volume is recycled back into the mixing device. In this example the hot gas is let in through the inlet tube sheet and into the distribution chamber. An air blower is used to drag the recycle from the main stream and force it into the mixing device.

1. A mixing device for mixing a first gas with a second gas wherein at least one of the first or the second gas is corrosive, the mixing device comprising:
a first inlet section
a second inlet section
an outlet section
a first duct sheet
a second duct sheet
a distribution chamber
at least two injection ducts arranged in said first duct sheet
at least two mixing ducts arranged in said second duct sheet,
wherein the space between the first duct sheet and the second duct sheet forms the distribution chamber and each of said at least two injection ducts corresponds to one of said at least two mixing ducts and wherein said mixing device is at least partly made of ceramic materials.

2. A mixing device according to claim 1, wherein the first and the second duct sheets, the distribution chamber and the at least two injection ducts and corresponding mixing ducts are at least partly made of ceramic materials.

3. A mixing device according to claim 1, wherein the circumference of the outlet of each of said at least two injection ducts is equal to or smaller than the circumference of the corresponding said mixing duct, each injection duct outlet centre-line is arranged in an angle of 0° to 90° to the corresponding mixing duct inlet centre-line.

4. A mixing device according to claim 1, wherein each injection duct outlet centre-line is arranged substantially parallel to the corresponding mixing duct inlet centre-line and said circumference of the outlet of each of the at least two injection ducts is arranged within said circumference of the corresponding mixing duct in cross sectional view.

5. A mixing device according to claim 1, wherein each of said at least two injection ducts are formed by an injection tube arranged in the first duct sheet.

6. A mixing device according to claim 1, wherein each of said at least two mixing ducts are formed by a mixing tube arranged in the second duct sheet and the circumference of the outlet of each of said at least two injection ducts is equal to or smaller than the circumference of the corresponding said mixing tube.

7. A mixing device according to claim 1, wherein each of said at least two injection ducts are formed by a bore in the first duct sheet.

8. A mixing device according to claim 1, wherein each of said at least two mixing ducts are formed by a bore in the second duct sheet.

9. A mixing device according to claim 1, wherein the circumference of the outlet of each said at least two injection tubes is smaller than the circumference of the inlet of the corresponding mixing duct and each of the at least two injection tubes are arranged partly within the corresponding mixing duct, whereby each of the at least two mixing ducts partly overlaps the corresponding injection tube in an axial direction.

10. A mixing device according to claim 1, wherein said first inlet section, said second inlet section and said outlet section is arranged such that the flow direction of the first gas in the first inlet section is substantially perpendicular to the flow direction of the second gas in the second inlet section.

11. A mixing device according to claim 1, wherein either the first or the second gas is a relative cold gas with at temperature below its dew point and the other gas is a relative hot gas with a temperature above its dew point, and the condensate of either or both the first and the second gas is corrosive.

12. A mixing device according to claim 1, wherein a mixing zone is formed within each of said at least two mixing ducts and the gas leaving said at least two mixing ducts has an average temperature above the dew point of the perfectly mixed gas.

13. A mixing device according to claim 1, wherein said corrosion resistant ceramic materials comprises at least one of
silicon carbide based materials, including reaction sintered, nitride bonded, oxide bonded and oxynitride bonded types
oxide based materials, including types based on silica or alumina
silicate and borosilicate based materials, including glass,
wherein said materials can be either impermeable or permeable to gas and liquid.

14. A mixing device according to claim 1, wherein at least one of the first or the second inlet section comprises a circumferential crevice adapted to pass a purge gas into said first or second inlet section.

15. A method for mixing a first gas and a second gas, the method comprising the steps of:
providing a mixing device for mixing the first gas with the second gas, the mixing device comprising:
a first inlet section
a second inlet section
an outlet section
a first duct sheet
a second duct sheet
a distribution chamber
at least two injection ducts arranged in said first duct sheet
at least two mixing ducts arranged in said second duct sheet,
wherein the space between the first duct sheet and the second duct sheet forms the distribution chamber and wherein said mixing device is at least partly made of ceramic materials,
providing a first flow comprising the first gas at the first inlet section,
providing a second flow comprising the second gas at the second inlet section,
mixing the first gas and the second gas in a mixing zone formed within each of the at least two mixing ducts, wherein the one of the two gasses is a relative cold corrosive gas with at temperature below its dew point and the other gas is a relative hot corrosive gas with a temperature above its dew point.

16. The method according to claim 15, wherein the first and the second duct sheets, the distribution chamber and the at least two injection ducts and corresponding mixing duct are made of corrosion resistant ceramic materials.

17. The method according to claim 15, wherein the first gas is a relative cold corrosive gas with at temperature below its dew point and the second gas is a relative hot corrosive gas with a temperature above its dew point.

18. The method according to claim 17, wherein the first gas has a temperature in the first inlet section in the range of 0° C.-200° C., preferably in the range of 145° C.-180° C. and the second gas has a temperature in the second inlet section in the range of 300° C.-600° C., preferably in the range of 360° C.-450° C.

19. Use of a mixing device according to claim 1 for a Sulphuric-Acid plant.
